(19) United States
(12) Patent Application Publication
(10) Pub. No.: US 2017/0144352 A1
(43) Pub. Date: May 25, 2017

(54) ROTARY SHAFT TYPE TURNTABLE POSITIONING DEVICE OF INJECTION MOLDING MACHINE

(71) Applicant: HWA CHIN MACHINERY FACTORY CO., LTD., TAINAN CITY 710 (TW)

(72) Inventor: CHING KUN YANG, TAINAN CITY 710 (TW)

(21) Appl. No.: 14/945,773

(22) Filed: Nov. 19, 2015

(51) Int. Cl. B29C 45/80; B29C 45/06; B29C 45/26; B29C 45/04

(52) U.S. Cl. CPC B29C 45/80; B29C 45/045; B29C 45/062; B29C 45/2681; B29C 2945/76762; B29C 45/16

(57) ABSTRACT

A rotary-shaft type turntable positioning device of an injection molding machine includes a first encoder and a second encoder installed at a servomotor of a positioning device and a speed reducer respectively, so that after the injection molding machine finishes an injection molding, the servomotor is used to drive the driving shaft and link the output shaft to drive the driving wheel to rotate a rotary shaft, while rotating and positioning a turntable. During rotation, signals of the first encoder and the second encoder are sensed to adjust the position, so as to control the turntable to be rotated to a precise position.

### FIELD OF THE INVENTION

The present invention relates to a positioning device, in particular a positioning device capable of controlling a rotary-shaft type turntable of an injection molding machine to be rotated to and positioned at a precise position.

### BACKGROUND OF THE INVENTION

Double color injection molding refers to a plastic injection molding of two or more colors, so that the manufactured products have the effects of two or more colors or materials. When a double color injection molding machine is operated, male and female molds are mounted on a mold plate that can be rotated reciprocally within 180 degrees. After the male and female molds are engaged, a first material feeding step is performed, and then the molds are opened, and the mold plate is rotated by 180 degrees to switch to a male mold position, and the male and female molds are engaged again before performing a second material feeding step, and finally the molds are opened and separate to finish the injection molding process and produce a product. The methods of rotating the conventional mold plate include a rotary-shaft method, a turntable-method, or a combination of the methods applied to the injection molding machine. As to the rotary-shaft method, an output shaft of the speed reducer is rotated by a belt which is looped round the gear of the rotary shaft, so that a mold fixed onto the rotary shaft can be rotated, and an encoder installed to a motor is provided for positioning the turntable. Although this method achieves the positioning effect, yet a backlash occurs easily when the reduction gear installed in the speed reducer is transmitted, and thus resulting in inaccurate positioning.

As disclosed in R.O.C. Pat. No. 498840 entitled “Improved mold turntable positioning structure of an injection molding machine”, two hydraulic shock absorbers are mounted to the top and bottom of the middle of the front wall of the injection molding machine by a positioning seat, and an impact plate is installed at the top of the middle of an outer wall of the turntable, so that the left sidewall of the impact plate abuts an operating end of the hydraulic shock absorber, and the turntable is driven by an hydraulic motor and a power shaft installed at a gear holder at the top of the wall of the injection molding machine to drive a driving gear, a driven gear, and a gear of the turntable to rotate sequentially and linked with the turntable for rotation, the impact plate rotates with the turntable synchronously, and when the right sidewall of the rotating impact plate abuts an operating end at the bottom of the hydraulic shock absorber, the rotating turntable eliminates the high-speed impact by the hydraulic shock absorber, so that the rotating impact plate is stopped and positioned instantly to reduce the time of the mold rotation cycle.

As disclosed in R.O.C. Pat. No. M497087 entitled “Double color injection molding machine with rotary shaft and turntable functions”, the machine comprises a turntable and a rotary shaft installed on the main body, and the turntable has a slot, and the main body has a rotary shaft sleeve, and the rotary shaft sleeve is passed into the turntable slot, and a first bearing corresponsive to the rotary shaft sleeve is installed in the slot and driven by a servomotor, so that when a mold is rotated by a rotary-shaft method, the servomotor drives a driving wheel to link a transmission belt, and the transmission belt drives a driven wheel of the rotary shaft sleeve. As a result, the rotary shaft sleeve and the rotary shaft are rotated simultaneously to achieve the positioning effect.

As disclosed in R.O.C. Pat. No. M476047 entitled “Injection molding machine turntable controlling device”, a servomotor is connected to a turntable mechanism, and a position recorder is provided for outputting position data of the turntable mechanism. After the servo driver receives the position data transmitted from the position recorder, electric power is supplied to drive the servomotor, and the servo driver knows the current position of the turntable mechanism according to the position data outputted by the position recorder to drive the servomotor to control the turntable mechanism to be moved to a target position precisely.

### SUMMARY OF THE INVENTION

In view of the drawbacks of the conventional method of rotating a rotary-shaft type mold plate that uses a servomotor and a speed reducer to drive the rotary shaft to be rotated and positioned, but the reduction gear of the speed reducer may produce a backlash to cause inaccurate positioning, the inventor of the present invention designed and developed a rotary-shaft type turntable of an injection molding machine in accordance with the present invention.

The present invention adds an encoder installed in the rotary-shaft type turntable positioning device, and uses at least two encoders to lower the error value of gear gap, so as to achieve an inaccurate positioning effect.

To achieve the aforementioned and other objectives, the present invention provides a rotary-shaft type turntable positioning device of an injection molding machine installed at a movable mold base, and the movable mold base includes a rotary shaft sleeve having a driven wheel installed therein, and the positioning device comprises: a rotary shaft, installed in the rotary shaft sleeve, and having a turntable installed at an end of the rotary shaft; a displacement driving mechanism, installed an end of the rotary shaft without the turntable, and provided for driving the rotary shaft to move horizontally; a servomotor, having a first encoder and a driving shaft, wherein the servomotor is capable of rotating the driving shaft according to a received signal, and the first encoder is capable of sending a rotation signal of the driving shaft and transmitting the sensed signal to a central control unit; a speed reducer, installed at the servomotor and having a reduction gear driven by the driving shaft, and the reduction gear having an output shaft, and the output shaft having a second encoder and a driving wheel, and the second encoder being provided for sensing the rotation signal of the output shaft and transmitting the sensed signal to the central control unit; a central control unit, for transmitting a signal to the servomotor and receiving a signal from the first encoder and second encoder according to a default value; and a transmission belt, looped over the driving wheel and the driven wheel, and driven by the servomotor to drive the driving shaft to link the output shaft and drive the driving wheel to rotate the rotary shaft.

Based on the aforementioned structure, the rotary-shaft type turntable positioning device of the present invention uses the displacement driving mechanism to control the rotary shaft installed at the turntable to move forward or retract for the operation of engaging or opening the male and female molds. After the injection molding is completed, the servomotor drives the output shaft of the speed reducer to rotate the driving wheel, and the transmission belt drives the rotary shaft to rotate and position the turntable simultaneously. During rotation, the first encoder installed at the servomotor and the second encoder installed at the speed reducer sense a signal to adjust the speed and position feedback, so that the servomotor can rotate the turntable to a precise position to achieve a quick positioning effect.

### BRIEF DESCRIPTION OF THE DRAWINGS

FIG. 1 is a block diagram of an injection molding machine of the present invention;

FIG. 2 is a front view of an injection molding machine of the present invention;

FIG. 3 is a schematic view of a rotary shaft of an injection molding machine of the present invention, wherein the rotary shaft is pushed forward; and

FIG. 4 is a schematic view of a rotary shaft of an injection molding machine of the present invention, wherein the rotary shaft is retracted.

### DESCRIPTION OF THE PREFERRED EMBODIMENTS

The aforementioned and other objectives and advantages of the present invention will become clearer in light of the following detailed description of an illustrative embodiment of this invention described in connection with the drawings. It is intended that the embodiments and drawings disclosed herein are to be considered illustrative rather than restrictive.

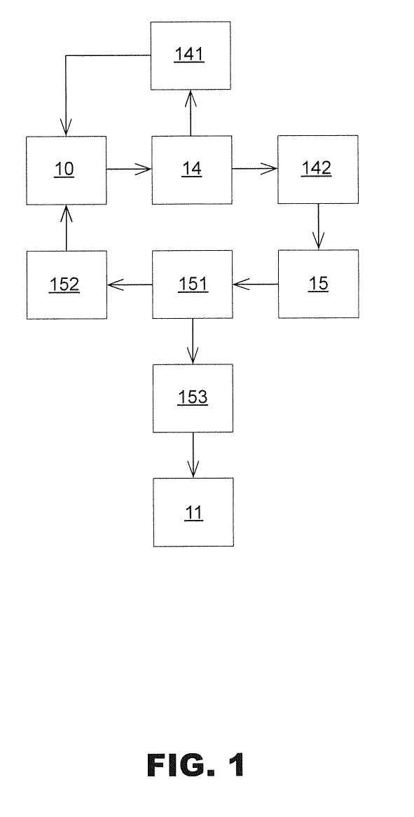

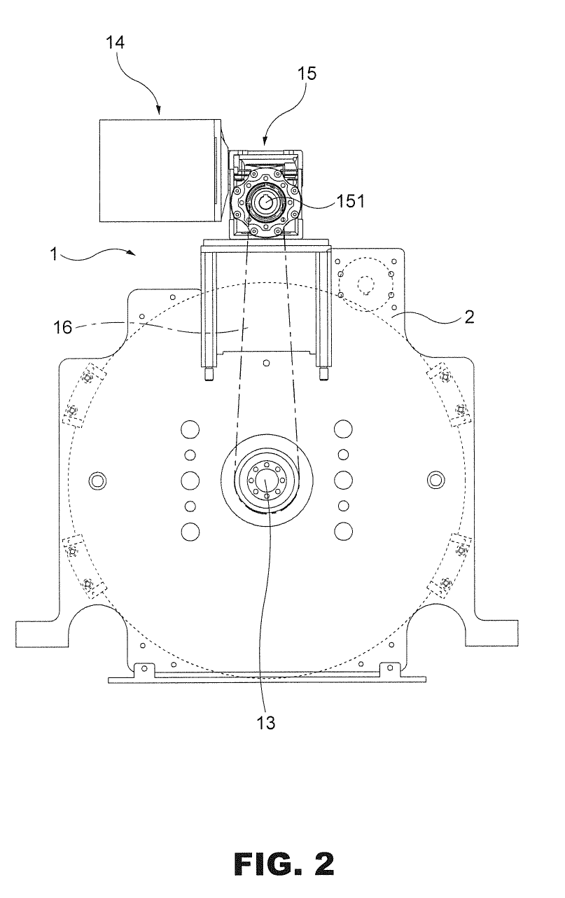

With reference to FIGS. 1 to 3 for an injection molding machine rotary shaft turntable positioning device of the present invention, the injection molding machine rotary shaft turntable positioning device 1 is installed at a movable mold base 2, and the movable mold base 2 includes a rotary shaft sleeve 3 installed therein, and the rotary shaft sleeve 3 has a driven wheel 31, and the positioning device 1 comprises a rotary shaft 11, a displacement driving mechanism 13, a servomotor 14, a speed reducer 15, a central control unit 10 and a transmission belt 16. The rotary shaft 11 is installed in the rotary shaft sleeve 3, and a turntable 12 is installed at an end of the rotary shaft 11. The displacement driving mechanism 13 is installed at an end of the rotary shaft 11 without the turntable 12 and provided for driving the rotary shaft 11 to move horizontally. The servomotor 14 has a first encoder 141 and a driving shaft 142, and the servomotor 14 rotates the driving shaft 142 according to the received signal. The first encoder 141 is provided for sensing a rotation signal of the driving shaft 142. The speed reducer 15 is installed at the servomotor 14 and has a reduction gear 150 driven by the driving shaft 142, and the reduction gear 150 has an output shaft 151, and the output shaft 151 has a second encoder 152 and a driving wheel 153. The central control unit 10 transmits a signal to the servomotor 14 according to a default value and receives the sensed signal fed back from the first encoder 141 and the second encoder 152. The transmission belt 16 is looped over the driving wheel 153 and the driven wheel 31 of the rotary shaft sleeve 3.

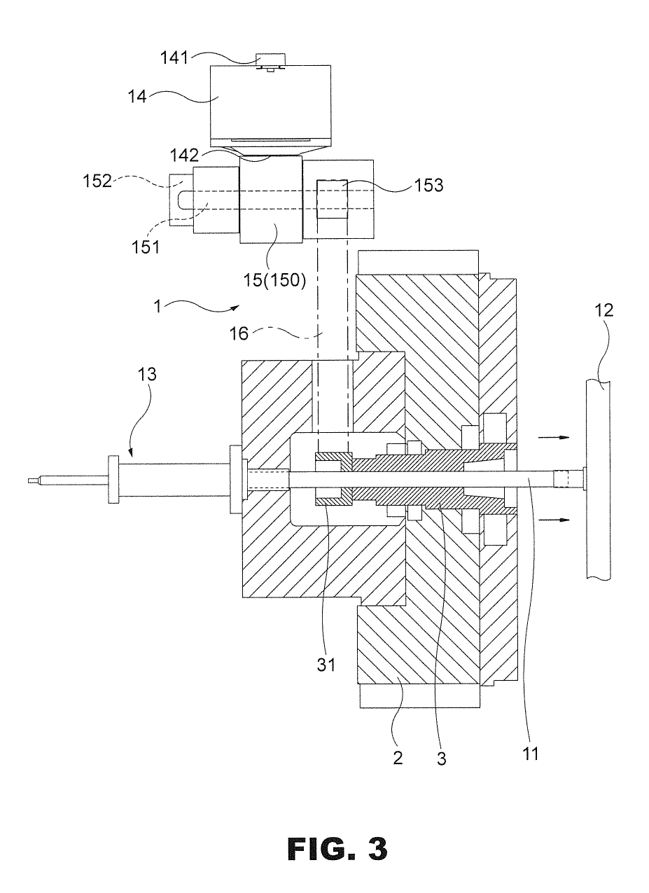

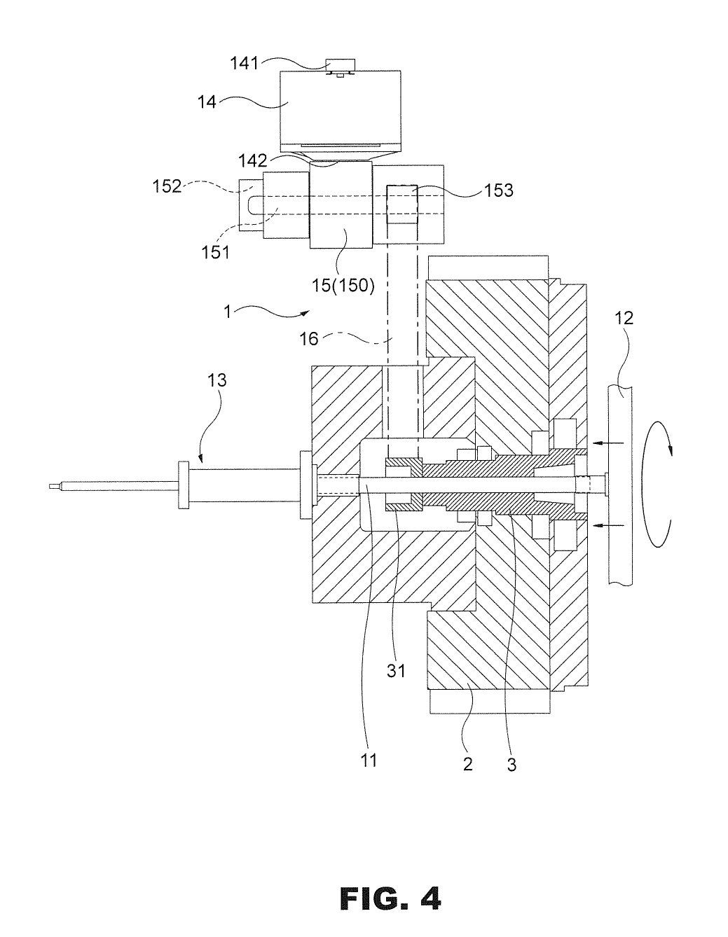

In FIGS. 1 and 3, when the injection molding machine adopts a rotary-shaft type turntable, the male mold is mounted onto the turntable 12, and the displacement driving mechanism 13 is operated to push the turntable 12 until the male mold is closely engaged with the female mold (as indicated by the arrow in the figure). After the male and female molds are engaged, a first injection molding takes place. After the injection molding is completed, the displacement driving mechanism 13 is operated again to pull the turntable 12 back to its original position as shown in FIG. 4, so that the male mold is separated from the female mold, and then the speed and position (number of rounds) set by the central control unit 10 are received, and a pulse signal generated by the speed and position feedback is converted into a position signal to generate an appropriate voltage command in order to rotate the driving shaft 142 of the servomotor 14, and the servomotor 14 is driven while the first encoder 141 senses a rotation signal of the servomotor 14. After the central control unit 10 receives the signal of the first encoder 141, the rotation speed of the servomotor 14 is adjusted, and the driving shaft 142 drives the output shaft 151 of the reduction gear 150 of the speed reducer 15 to rotate while the second encoder 152 senses a rotation signal of the output shaft 151. If the central control unit 10 receives the signal of the second encoder 152 and the set position signal and the reduction gear 150 has an error due to the backlash, the central control unit 10 will re-adjust the command to the servomotor 14, so that the driving shaft 142 is rotated to drive the output shaft 151 of the speed reducer 15 to rotate. If the central control unit 10 receives a signal of the second encoder 152 which is in compliance with the set position signal, the output shaft 151 will drive the driving wheel 153 to rotate while the transmission belt 16 drives the rotary shaft 11, so that the turntable 12 fixed to the rotary shaft 11 can be rotated to a predetermined position, and then the displacement driving mechanism 13 pulls the rotary shaft 11 back again, and the male and female molds are engaged for the secondary injection.

By the first encoder 141 and the second encoder 152 installed at the servomotor 14 and the speed reducer 15 respectively, the signal transmitted from the first encoder 141 and the second encoder 152 to the central control unit 10 may be used to confirm whether or not there is an error occurred when the servomotor 14 drives the driving shaft 142 and the speed reducer 15. After the error is corrected, a command is transmitted to the servomotor 14 to control the rotation of the driving shaft 142, the speed reducer 15 and the driving wheel 153, so as to position the rotary shaft 11 precisely.

What is claimed is:

1. A rotary-shaft type turntable positioning device of an injection molding machine, and the positioning device being installed at a movable mold base, and the movable mold base including a rotary shaft sleeve with a driven wheel installed therein, and the positioning device comprising:
a rotary shaft, installed in the rotary shaft sleeve, and having a turntable installed at an end of the rotary shaft;
a displacement driving mechanism, installed an end of the rotary shaft without the turntable, and provided for driving the rotary shaft to move horizontally;
a servomotor, having a first encoder and a driving shaft, wherein the servomotor is capable of rotating the driving shaft according to a received signal, and the first encoder is capable of sending a rotation signal of the driving shaft and transmitting the sensed signal to a central control unit;
a speed reducer, installed at the servomotor and having a reduction gear driven by the driving shaft, and the reduction gear having an output shaft, and the output shaft having a second encoder and a driving wheel, and the second encoder being provided for sensing the rotation signal of the output shaft and transmitting the sensed signal to the central control unit;
a central control unit, for transmitting a signal to the servomotor and receiving a signal from the first encoder and second encoder according to a default value; and
a transmission belt, looped over the driving wheel and the driven wheel, and driven by the servomotor to drive the driving shaft to link the output shaft and drive the driving wheel to rotate the rotary shaft.

2. The rotary-shaft type turntable positioning device of an injection molding machine, as recited in claim 1, wherein, the first encoder and the second encoder are rotary encoders.
